(19) United States
(12) Patent Application Publication
(10) Pub. No.: US 2025/0224056 A1
(43) Pub. Date: Jul. 10, 2025

(54) System for circulating fluid between at least two hollow bodies or housings

(71) Applicant: SOGEFI AIR & COOLING, GUYANCOURT (FR)

(72) Inventors: Boris COLIN, ORBEY (FR); Arnaud SCHUB, INGERSHEIM (FR)

(21) Appl. No.: 17/766,427

(22) PCT Filed: Oct. 9, 2020
(86) PCT No.: PCT/EP2020/078444

§ 371 Date: Apr. 4, 2022

Related U.S. Application Data
(60) Provisional application No. 62/913,917, filed on Oct. 11, 2019.

(51) Int. Cl. F16L 27/12

(52) U.S. Cl. CPC F16L 27/125

(57) ABSTRACT

The invention relates to a system for circulating fluid between at least one first body or housing (2) and at least one second body or housing (3), the system comprising an arrangement of multiple fluid connections (4, 4′, 4″, 4″) between, on the one hand, the first body or housing (2) provided with at least two mutually separate openings (5, 5′, 5″, 5″) and, on the other hand, at least one second body or housing (3) also comprising mutually separate openings, each connection establishing a sealed fluid connection between an opening of the first body or housing (2) and an opening of the second body or housing (3), or of one of the second bodies or housings. Said system (1) is characterised in that each of the fluid connections (4, 4′, 4″, 4″) is rigid but hinged, and formed by successive interlocking of a rigid female tubing (7, 7′, 7″, 7″) and a rigid or diabolo pipe (9, 9′, 9″).

The invention relates to the field of fluid circulation circuits, in particular the controlled circulation of liquid fluids.

In that context, and in particular in an environment under the hood of an internal combustion engine motor vehicle, it relates to a system for circulating fluid between at least two hollow bodies or housings, with the establishment of multiple leaktight fluidic links between such bodies, which can have variable relative positions (in particular with connection faces that do not face one another).

The above-mentioned links should moreover be able to accommodate manufacturing and assembly tolerances and deformations during operation.

A fluid circulation system as mentioned hereinabove generally consists of at least two—and generally multiple—functional housings that are connected to one another. The reference faces at which these functional housings are attached and connected are not necessarily the same. Added to this are the manufacturing tolerances for the various functional housings of the circuit, the small operational deformations (expansion, variations in pressure, etc.). The task is therefore that of:—connecting the various functional housings to one another, it being necessary to compensate for these tolerances,—to have a certain flexibility in order to absorb small functional deformations (expansion, variations in pressure, vibration, etc.), all while ensuring that the circulation system is leaktight (specifically that the internal fluid cannot escape).

This function is generally served by elastomer-based flexible pipes (often called “hoses”) which have good leaktightness and flexibility properties.

The distances/paths between the various interfaces can be varied and can therefore require the management of a large variety of hose types.

In addition, it is recommended to provide at least one additional intermediate attachment (between its two connected ends) in the event of significant length, non-straight conformation and/or sensitive environment.

Moreover, the automation, or even the simple mechanization, of the installation of flexible hoses is difficult and delicate. It is often necessary to resort to fully manual installation. This is all the more so since leaktight connection requires the installation of a collar, and push-fitting onto a fitting having a particular shape (olive fitting).

The present invention aims to overcome these drawbacks.

To that end, the invention principally relates to a system for circulating fluid between at least one first body or housing and at least one second body or housing comprising an arrangement of multiple fluidic links between, on one hand, said first body or housing provided with at least two mutually distinct openings and, on the other hand, at least one second body or housing also comprising mutually distinct openings, each link establishing a leaktight fluidic connection between an opening of the first body or housing and an opening of the second body or housing, or of one of the second bodies or housings,
this system being characterized
in that each one of the fluidic links is rigid but articulated,
in that each opening in question of the first body or housing is provided with a corresponding rigid female tube, which may be straight, curved or angled, and each opening in question of the second body or housing, or of the second bodies or housings, is provided with a corresponding rigid male fitting, and in that rigid ducts or diabolos of suitable shape are nested, on one hand, in respective female tubes of the first body or housing and, on the other hand, on respective male fittings of the second body(-ies) or housing(s),
each nested [tube/duct/fitting] assembly (consisting of tubular elements made of rigid plastic and nested in one another) constituting a leaktight fluidic link provided with a limited capability of at least relative rotational/translational/angular displacement, at least at the relevant [tube/duct] nesting, and possibly also at the relevant [duct/fitting] nesting.

The invention will be understood better thanks to the following description, which relates to a preferred embodiment that is given by way of nonlimiting example and is explained by reference to the appended schematic drawings, in which:

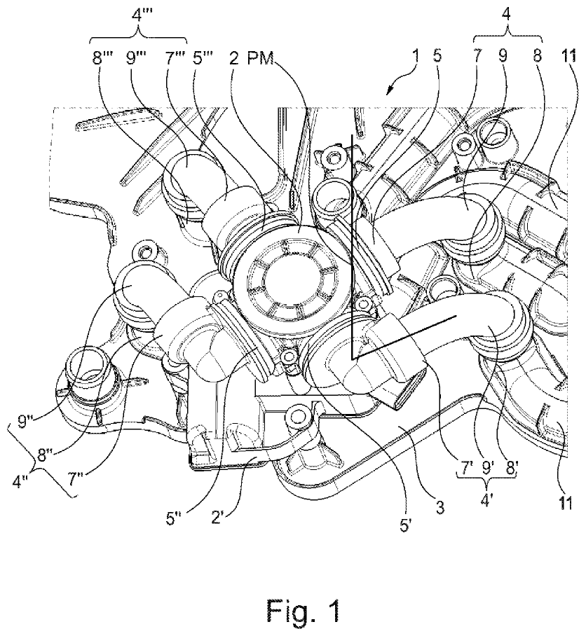

FIG. 1 shows a partial perspective view from above of a fluid (liquid) circulation system in accordance with one embodiment of the invention, comprising a first functional housing in the form of a directional control valve or housing and a second body in the form of a directional control or distribution plate;

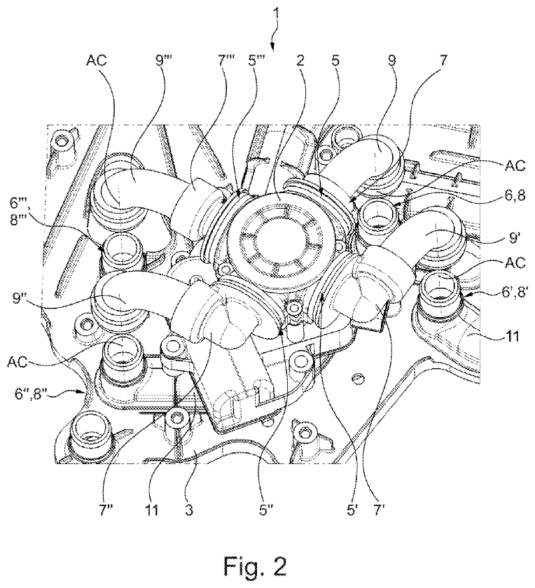

FIG. 2 is a view similar to that of FIG. 1, the pre-installed module incorporating the valve (housing+actuator) being about to be joined to the distribution plate to form the circulation system;

FIG. 3 shows a detail view of one of the fluidic links of the system shown in FIG. 1, on another scale and in section along the plane PM;

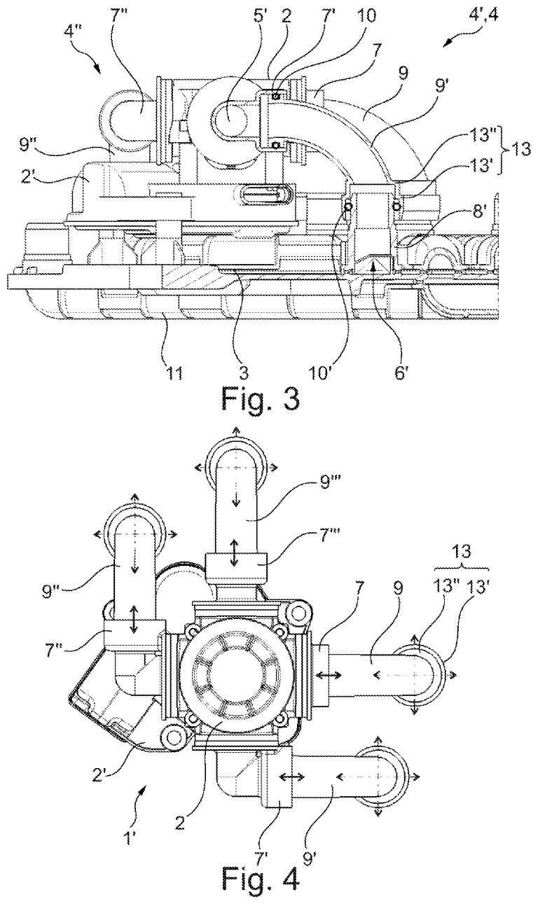

FIG. 4 is a top view of the pre-installed module of FIG. 2, with an illustration of the limited capabilities of articulation and relative displacement at the level of the nesting interfaces;

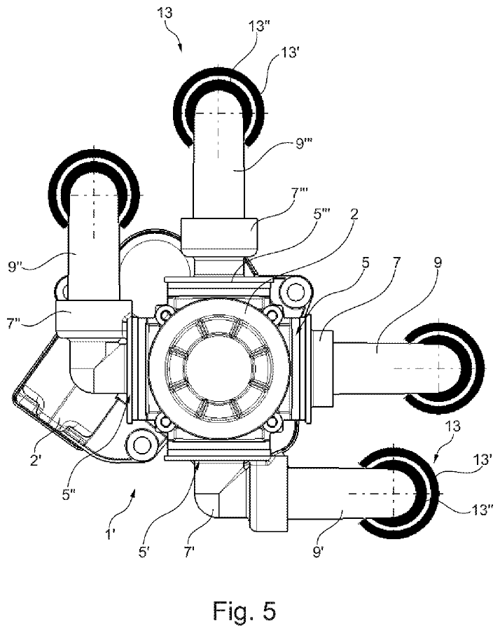

FIG. 5 is a top view of the pre-installed module, similar to that of FIG. 4, but on a different scale and with highlighting of the gripping and bearing regions;

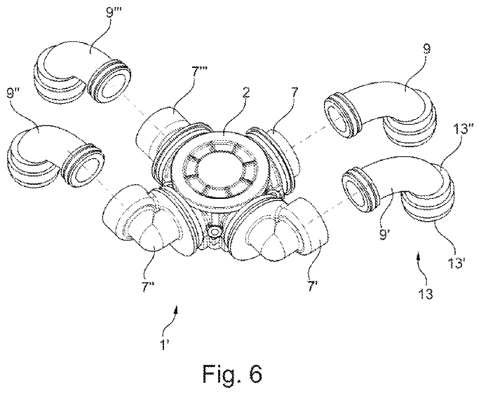

FIG. 6 is a perspective and partially exploded view of the module shown in FIG. 5 (but not including the actuator, this being a possible pre-installing variant of the module), and

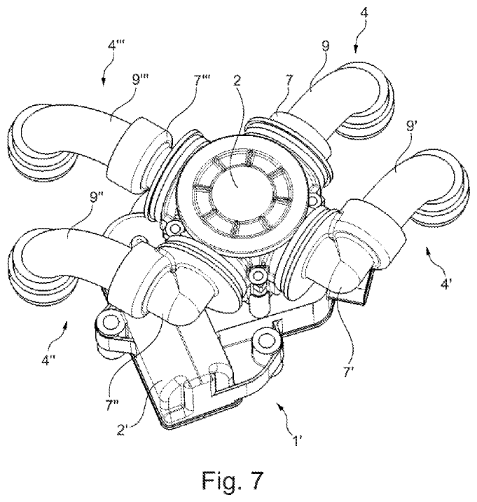

FIG. 7 is a perspective view of the pre-installed module of FIGS. 4 to 6, also incorporating the actuator, according to a variant embodiment.

FIGS. 1 to 3 show, at least in part, a system (1) for circulating fluid between at least one first body or housing (2) and at least one second body or housing (3) comprising an arrangement of multiple fluidic links (4, 4′, 4″, 4″) between, on one hand, said first body or housing (2) provided with at least two mutually distinct openings (5, 5′, 5″, 5″) and, on the other hand, at least one second body or housing (3) also comprising mutually distinct openings (6, 6′, 6″, 6″), each link establishing a leaktight fluidic connection between an opening of the first body or housing (2) and an opening of the second body or housing (3), or of one of the second bodies or housings.

According to the invention, this system (1) is characterized in that each of the fluidic links (4, 4′, 4″, 4″) is rigid but articulated, in that each opening (5, 5′, 5″, 5″) in question of the first body or housing (2) is provided with a corresponding rigid female tube (7, 7′, 7″, 7″), which may be straight, curved or angled, and each opening (6, 6′, 6″, 6″) in question of the second body or housing (3), or of the second bodies or housings, is provided with a corresponding rigid male fitting (8, 8′, 8″, 8″), and in that rigid ducts or diabolos (9, 9′, 9″, 9″) of suitable shape are nested, on one hand, in respective female tubes (7, 7′, 7″, 7″) of the first body or housing (2) and, on the other hand, on respective male fittings (8, 8′, 8″, 8″) of the second body(-ies) or housing(s) (3).

Thanks to these provisions, each nested [tube (7, 7′, 7″, 7′)/duct (9, 9′, 9″, 9′″)/fitting (8, 8′, 8″, 8″)] assembly (consisting of tubular elements made of rigid plastic and nested in one another) constitutes a leaktight fluidic link (4, 4′, 4″, 4″) provided with a limited capability of at least relative rotational/translational/angular displacement, at least at the relevant [tube/duct] nesting, and possibly also at the relevant [duct/fitting] nesting.

Thus, each fluidic connection comprises three rigid tubular segments of different types (tubes, ducts, fittings) that are fluidically and mechanically connected in series in pairs by means of nesting connections, with provision of a limited possibility of articulation at the level of each nesting of two consecutive segments. The articulation comes from a limited capability of relative displacement between two mutually nested segments, where this possible displacement can be rotary and/or translational, or can even comprise a component of movement that modifies the orientation between the segments in question (swiveling). To allow these relative articulation movements, the male and female tubular portions that overlap at the level of the nestings have sufficient radial clearances, suitable sealing means being interposed between these portions and serving, where necessary, to guide the relative displacement. The various nesting connections are configured to each allow axial tolerance management of approximately +/−3 mm, and swiveling of an amplitude suitable for establishing the portions of circulation lines (fluidic links (4, 4′, 4″, 4″)), with leaktightness being maintained under fluid pressures of 2 to 3 bars.

Owing to the segmentation of the fluidic links, complex shapes can be obtained with a limited number of different tubular elements and simple shapes: straight, angled, curved. In addition, the rigidity of said elements, in particular of the ducts (9, 9′, 9″, 9″), makes it possible to dispense with any intermediate attachment and to automate the assembly of the system (1) owing to the possibility of reliable gripping, precise positioning and transmission of forces during nesting.

The advantages of the invention are particularly beneficial when the arrangement of multiple fluidic links comprises at least three, preferably at least four, distinct fluidic links (4, 4′, 4″, 4″).

In order to compensate in particular for manufacturing and assembly discrepancies, it is advantageously provided that each leaktight fluidic link (4, 4′, 4″, 4″) has a limited capability of articulation at least at its respective [tube (7, 7′, 7″, 7″)/duct (9, 9′, 9″, 9″)] nesting, and possibly also at its respective [duct (9, 9′, 9″, 9″)/fitting (8, 8′, 8″, 8″)] nesting.

In order to facilitate the assembly of the system (1) and in particular to make it possible to simultaneously nest all the ducts on the fittings, the rigid male fittings (8, 8′, 8″, 8″) of the second body(-ies) or housing(s) (3) are all straight and have the same orientation, their central axes (AC) being mutually parallel.

Each [tube/duct] pair is then configured, by choosing tubular segments (7, 7′, 7″, 7″) and (9, 9′, 9″, 9″) of appropriate shapes and dimensions and by choosing suitable orientations, so that the female ends (13) of the ducts are all positioned facing the fittings such that a single translational movement of said ducts results in synchronous assembly by multiple duct-tube nestings.

As shown in FIGS. 1 to 3, the face or faces of the first body (2) comprising the openings (5, 5′, 5″, 5″), on one hand, and the face or faces of the second body(-ies) (3) comprising the openings (6, 6′, 6″, 6″) are for example oriented perpendicular to each other. Advantageously, the respective faces of the first body (2) are lateral faces thereof, located on several sides and oriented, in relation to the arrangements of the openings that are to be connected of the second body(-ies) (3), in such a way that the fluidic links have simple shapes, with only one curve/angle (cf. 4 and 4′″: curved ducts 9 and 9″) or at most two bends/angles in two different planes (cf. 4′ and 4″: angled tubes 7′ and 7″ and curved ducts 9′ and 9″).

According to another feature of the invention, the rigid female tubes (7, 7′, 7″, 7″) consist of tubular connectors (which are for example straight or angled) attached at the level of the respective openings (5, 5′, 5″, 5″) in question of the first body or housing (2), being rigidly secured (to said body or housing), for example by welding.

In accordance with another feature of the invention, which can be seen in FIGS. 3 and 4, it is advantageously provided that at least one, and preferably each, [tube (7, 7′, 7″, 7″)/duct (9, 9′, 9″, 9″)] nesting is configured to allow limited swiveling, leaktightness being retained at the nesting in question.

Alternatively, or in addition to the previous arrangement, provision may be made for at least one, and preferably each, [tube (7, 7′, 7″, 7″)/duct (9, 9′, 9″, 9″)] nesting to be configured to also allow limited relative axial displacement (between the nested tube and duct), while maintaining leaktightness at the level of the nesting in question.

The two preceding arrangements each, in their own way, make it possible to easily accommodate geometric and dimensional discrepancies during the multiple assemblies between corresponding ducts and fittings.

In addition, in order to have an ability to adjust/compensate in the nesting direction, it can also be envisaged that at least one, and preferably each, [duct (9, 9′, 9″, 9″)/fitting (8, 8′, 8″, 8″)] nesting allows at least limited axial displacement, while maintaining leaktightness at the level of the nesting in question.

Preferably, a compression seal (10, 10′), for example an O-ring or a lip seal, made of an elastomer material, is present at each [tube (7, 7′, 7″, 7″)/duct (9, 9′, 9″, 9″)] nesting, and preferably also at each [duct (9, 9′, 9″, 9″)/fitting (8, 8′, 8″, 8″)] nesting, so as to provide axial and/or radial leaktightness depending on the nesting in question. An O-ring 10 can advantageously promote or guide the limited swiveling between mutually nested tube and duct.

According to a first variant embodiment of the invention, each [duct (9, 9′, 9″, 9′″)/fitting (8, 8′, 8″, 8″)] nesting, and advantageously also each [tube (7, 7′, 7″, 7″)/duct (9, 9′, 9″, 9′)] nesting, comprises a releasable locking means (12). The latter may for example consist of a key, a clip, a circlip, a screw or a similar fastening and locking element.

According to another variant embodiment of the invention, each [duct (9, 9′, 9″, 9″)/fitting (8, 8′, 8″, 8″)] nesting may also be locked by welding, in particular friction welding or vibration welding, the leaktightness at this nesting being obtained either directly by said connection by welding, or by interposition of a compression seal (10′).

In accordance with a very advantageous structural feature of the invention, illustrated in FIGS. 3, 5 and 6 and favorable to assembly in terms of handling, positioning and assembly, the female end (13) of each duct (9, 9′, 9″, 9″) joined by nesting to a male fitting (8, 8′, 8″, 8′) comprises at least one gripping region (13′), for example in the form of a cylindrical skirt portion, and at least one bearing region (13″), for example in the form of at least one shoulder.

By providing a double shoulder at the ends (13) of the ducts as illustrated in the aforementioned figures, it is possible to spatially differentiate the gripping and bearing functions, or else to have a double bearing region.

In order to facilitate the handling and assembly of the various components of the system (1), and also to make the automation of these operations easier, it is preferably provided, as shown in FIGS. 2 and 4 to 6, that the first body or housing (2) constitutes, with the various [tube/duct] pairs of mutually nested tubular elements that are associated therewith, a preassembled unit (1′), of the pre-assembled functional and structural module type. Obtaining the system (1) then only requires the assembly of this module (1′) with the second body(-ies) (3) by nesting the female ends (13) of the ducts on the fittings.

According to a preferred implementation of the invention, in connection with a circulation system (1) used for liquid fluid and installed under the hood, the first body (2) consists of a valve body of the directional control type having at least two ports, preferably having at least three or four ports, and the second body (3) consists of a directional control plate, preferably of the type including rigidly-interconnected ducts (11), these being advantageously located in a single plane and each terminating at one of its ends in a respective fitting (8, 8′, 8″, 8″).

As shown in FIGS. 1, 3 and 7, an actuator (2′) installed in a protective housing is associated with the valve body (2)—containing the chamber and the distribution member—and the two together form a valve controlling the distribution and circulation of fluid between the various leaktight fluidic connection lines (4, 4′, 4″, 4″). This actuator (2′) is positioned under the valve body (2), between the latter and the second body (2), to which said actuator (2′) is advantageously attached. This thus leads to a compact, low-profile construction that allows easy access to the fluidic links, and with the module (1′) being strongly secured to the second body (3).

The invention also relates, as shown in FIGS. 2 and 4 to 6, to a fluidic module (1′) that is intended to be part of a fluid circulation system (1) as described above.

This module (1′) consists of a pre-assembled functional and structural unit (1′) that includes, on one hand, a first body or housing (2) provided with at least two distinct openings (5, 5′, 5″, 5″) each provided with a corresponding rigid female tube (7, 7′, 7″, 7″) that is straight, curved or angled and, on the other hand, suitably shaped rigid ducts or diabolos (9, 9′, 9″, 9″) that are respectively nested in said various female tubes (7, 7′, 7″, 7″). These various [tube (7, 7′, 7″, 7″)/duct (9, 9′, 9″, 9″)] pairs of mutually nested rigid tubular elements are configured to each constitute, in cooperation by nesting with a respective male fitting (8, 8′, 8″, 8″) of at least one second body or housing (3), a leaktight fluidic link (4, 4′, 4″, 4″) that is provided with a limited capability at least of relative rotational/translational/angular displacement, between these first and second bodies or housings (2 and 3).

The various combinations of nested [tube/duct] tubular segments are shaped and dimensioned in such a way that the female ends (13) of the ducts (9, 9′, 9″, 9″), that are intended to be joined by nesting to the male fittings (8, 8′, 8″, 8″), are arranged relative to one another and positioned with respect to the first body or housing (2) so as to match, with manufacturing tolerances and with limited possibility of adjustment, the mutual arrangement of the male fittings (8, 8′, 8″, 8″) respectively corresponding to the second body or housing (3) and their positions with respect to the latter.

Finally, the invention also relates to a method for creating a system (1) for circulating fluid between at least one first body or housing (2) and at least one second body or housing (3).

As indicated above, this system (1) comprises an arrangement of multiple fluidic links (4, 4′, 4″, 4″) between, on one hand, said first body or housing (2) provided with at least two distinct openings (5, 5′, 5″, 5″) and, on the other hand, at least one second body or housing (6) comprising distinct openings (6, 6′, 6″, 6″), each link establishing a leaktight fluidic connection between an opening of the first body or housing (2) and an opening of the second body or housing (3), or of one of the second bodies or housings.

This method is characterized in that it consists:
in providing a first body or housing (2) of which each opening (5, 5′, 5″, 5″) is provided with a corresponding rigid female tube (7, 7′, 7″, 7″), which may be straight, curved or angled, at least one second body or housing (3) of which each opening (6, 6′, 6″, 6″) is provided with a corresponding rigid male fitting (8, 8′, 8″, 8″), and rigid ducts or diabolos (9, 9′, 9″, 9″) of suitable shape and configured to be nested, on one hand, in respective female tubes (7, 7′, 7″, 7″) of the first body or housing (2) and, on the other hand, on respective male fittings (8, 8′, 8″, 8″) of the second body(-ies) or housing(s) (3), and
in creating nested [tube/duct/fitting] assemblies (consisting of tubular elements made of rigid plastic and nested in one another) each constituting a leaktight fluidic link (4, 4′, 4″, 4″) and each provided with a limited capability of at least relative rotational/translational/angular displacement, at least at the relevant [tube/duct] nesting, and possibly also at the relevant [duct/fitting] nesting, so as to obtain fluidic links (4, 4′, 4″, 4″) that are rigid but articulated.

Advantageously, this method may consist, in a separate and preliminary operating phase, in producing a functional and structural module (1′) that is pre-installed either by assembling the first body or housing (2) with the various mutually pre-nested [tube/duct] pairs of tubular elements that are associated therewith, or by assembling the female tubes (7, 7′, 7″, 7″) with said first body or housing (2), then assembling by nesting the rigid ducts or diabolos (9, 9′, 9″, 9″) with the respectively corresponding tubes (7, 7′, 7″, 7″), and then mechanically and fluidically joining this module (1′), by installing in a direction parallel to the central axes of the rigid straight male fittings (8, 8′, 8″, 8″) and multiple nestings of the rigid ducts or diabolos (9, 9′, 9″, 9″) on these fittings (8, 8′, 8″, 8″), to said at least one second body or housing (3) so as to form the fluid circulation system (1).

Preferably, the joining of the pre-installed module (1′) to said at least one second body or housing (3) is carried out at a robot-equipped station, either fully automatically by an autonomous robot, or semi-automatically using a cobot or assistance robot.

In the context of a particularly advantageous implementation, the method for creating a system (1) as mentioned above is aimed at a method involving a first phase of assembling a module (1′) in which is integrated at least part of a multi-port directional control valve (2) and a second phase of installing this pre-assembled module (1′) on a distribution plate (3), this by simply nesting the ducts of the module onto the fittings of the plate, if necessary using a suitable tool, and optionally in an at least partially automated manner. The module (1′) can preferably comprise the entire valve, i.e. the valve body (2) and the actuator (2′), as shown in FIGS. 5, 5 and 7, or, as shown in FIG. 6, only the valve body. In the latter case, the actuator (2′) can be pre-installed on the second body (3) and the assembly of the valve body with the actuator (to form the functional valve) is done during assembly of the module (1′) on the second body (3).

The fluid circulation system (1) described above mainly and simultaneously serves the following purposes:
to connect the various functional housings to one another, with the possibility of compensating for the manufacturing and installation/assembly tolerances,
to have a degree of flexibility to absorb small functional deformations (expansion, pressure variations, etc.)
while ensuring leaktightness of the circulation system (to prevent the internal fluid escaping).

Compensating for tolerances, and the flexibility to absorb small functional deformations, are made possible by functional clearances at the level of the two articulated nestings of each of the ducts, which will allow the duct in question to slide and/or to swivel at these nesting connection interfaces.

In the context of increasing ergonomic requirements (installation effort, simplification of assembly), the automation of the assembly of the modules (1′) or the installation of the modules (1′) on the plates (3) is a definite advantage. The concept of the invention, of rigid tubular segments, makes this automation possible since a force applied to such a segment, will, by the very rigidity of this segment, be converted into an assembly/insertion/nesting force of this same segment (this is more particularly the case for ducts).

If necessary, each articulated nesting can be locked by a retaining means (see the examples mentioned above) which will make it possible, for example, to prevent separation under pressure, or the module (1′) or the system (1) coming apart during transport or handling.

Regarding the constituent materials of the various components of the system (1), these are thermoplastic materials. Thus, by way of example, the body of the housing (2), the tubes, the fittings and the diabolos can be made of PP-GF10, the body of the housing or plate (3) of PA66-GF30 and the seals (10 and 10′) of EPDM rubber.

Of course, the invention is not restricted to the embodiment described and shown in the accompanying drawings. Modifications remain possible, in particular as regards the makeup of various elements or by substitution of technical equivalents, without otherwise departing from the scope of protection of the invention.

1-19. (canceled)

20. A fluid module intended to form part of a system for circulating fluid between at least one first body or housing and at least one second body or housing, said system comprising:
an arrangement of multiple fluidic links between, on one hand, said first body or housing provided with at least two mutually distinct openings and, on the other hand, at least one second body or housing also comprising mutually distinct openings, each link establishing a leak-tight fluidic connection between an opening of the first body or housing and an opening of the second body or housing, or of one of the second bodies or housings, and each of the fluidic links being rigid but articulated,
wherein said fluid module is in the form of a pre-assembled functional and structural unit that includes, on one hand, said first body or housing whose distinct openings are each provided with a corresponding rigid female tube that is straight, curved or angled and, on the other hand, suitably shaped rigid ducts that are respectively nested in said various female tubes forming tube-duct pairs,
wherein said tube-duct pairs of mutually nested rigid tubular elements are configured to constitute, in respective cooperation by nesting with rigid male fittings fitted to the openings of said at least one second body or housing, a leak-tight fluidic link that is provided with a limited capability at least of relative rotational and angular, and possibly also translational displacement, between these first and second bodies or housings,
wherein each nested tube-duct-fitting assembly, including tubular elements made of rigid plastic and nested in one another, constitutes a leak-tight fluidic link provided with a limited capability of at least relative rotational and angular, and possibly also translational displacement, at least at the relevant tube-duct nesting, and possibly also at the relevant duct-fitting nesting,
wherein the first body is in the form of a valve body of the directional control type having at least two ports, preferably having at least three or four ports, and
wherein the second body is in the form of a directional control plate, preferably of the type including rigidly-interconnected ducts, these being advantageously located in a single plane and each terminating at one of its ends in a respective fitting.

21. The fluid module as claimed in claim 20, wherein the arrangement of multiple fluidic links comprises at least three, preferably at least four, distinct fluidic links.

22. The fluid module as claimed in claim 20, wherein each leak-tight fluidic link has a limited capability of articulation at least at its respective tube-duct nesting, and possibly also at its respective duct-fitting nesting.

23. The fluid module as claimed in claim 20, wherein the rigid male fittings of the second body(-ies) or housing(s) are all straight and have the same orientation, their central axes being mutually parallel.

24. The fluid module as claimed in claim 20, wherein the rigid female tubes are tubular connectors attached at the level of the respective openings in question of the first body or housing, being rigidly secured for example by welding.

25. The fluid module as claimed in claim 20, wherein at least one, and preferably each, tube-duct nesting is configured to allow limited swiveling, leak-tightness being retained at the nesting in question.

26. The fluid module as claimed in claim 25, wherein at least one, and preferably each, tube-duct nesting is configured to also allow limited relative axial displacement, leak-tightness being retained at the nesting in question.

27. The fluid module as claimed in claim 20, wherein at least one, and preferably each, duct-fitting nesting allows at least limited axial displacement, leak-tightness being retained at the nesting in question.

28. The fluid module as claimed in claim 20, wherein a compression seal, for example an O-ring or a lip seal, made of an elastomer material, is present at each tube-duct nesting, and preferably also at each duct-fitting nesting, so as to provide axial and/or radial leak-tightness depending on the nesting in question.

29. The fluid module as claimed in claim 20, wherein each duct-fitting nesting is locked by welding, in particular friction welding or vibration welding, the leak-tightness at this nesting being obtained either directly by said connection by welding, or by interposition of a compression seal.

30. The fluid module as claimed in claim 20, wherein each duct-fitting nesting, and advantageously each tube-duct nesting, comprises a releasable locking means.

31. The fluid module as claimed in claim 20, wherein the female end of each duct, joined by nesting to a male fitting comprises at least one gripping region, for example in the form of a cylindrical skirt portion, and at least one bearing region, for example in the form of at least one shoulder.

32. The fluid module as claimed in claim 20, wherein the first body or housing constitutes, with the various tube-duct pairs of mutually nested tubular elements that are associated therewith, a preassembled unit, of the pre-assembled functional and structural module type.

33. The fluid module as claimed in claim 20, wherein the female ends of the ducts, that are intended to be joined by nesting to the male fittings, are arranged relative to one another and positioned with respect to the first body or housing so as to match, with manufacturing tolerances and with limited possibility of adjustment, the mutual arrangement of the male fittings respectively corresponding to the second body or housing and their positions with respect to the latter.

34. A method for creating a system for circulating fluid between at least one first body or housing and at least one second body or housing, this system having
an arrangement of multiple fluidic links between, on one hand, said first body or housing provided with at least two distinct openings and, on the other hand, at least one second body or housing comprising distinct openings, each link establishing a leak-tight fluidic connection between an opening of the first body or housing and an opening of the second body or housing, or of one of the second bodies or housings,
Said method comprising the steps of:
providing a first body or housing of which each opening is provided with a corresponding rigid female tube, which may be straight, curved or angled, at least one second body or housing of which each opening is provided with a corresponding rigid male fitting, and rigid ducts of suitable shape and configured to be nested, on one hand, in respective female tubes of the first body or housing and, on the other hand, on respective male fittings of the second body(-ies) or housing(s), and
creating nested tube-duct-fitting assemblies, including tubular elements made of rigid plastic and nested in one another, each constituting a leak-tight fluidic link and each provided with a limited capability of at least relative rotational/translational/angular displacement, at least at the relevant tube-duct nesting, and possibly also at the relevant duct-fitting nesting, so as to obtain fluidic links that are rigid but articulated,
wherein said method includes, in a separate and preliminary operating phase, in producing a functional and structural module, as claimed in claim 20, that is pre-installed either by assembling the first body or housing with the various mutually pre-nested tube-duct pairs of tubular elements that are associated therewith, or by assembling the female tubes with said first body or housing, then assembling by nesting the rigid ducts or diabolos with the respectively corresponding tubes, and then mechanically and fluidically joining this module, by installing in a direction parallel to the central axes of the rigid straight male fittings and multiple nestings of the rigid ducts or diabolos on these fittings, to said at least one second body or housing so as to form the fluid circulation system.

35. The method as claimed in claim 34, wherein the joining of the pre-installed module to said at least one second body or housing is carried out at a robot-equipped station, either fully automatically by an autonomous robot, or semi-automatically using a cobot or assistance robot.
